(19) United States
(12) Patent Application Publication
(10) Pub. No.: US 2001/0048183 A1
(43) Pub. Date: Dec. 6, 2001

(54) Optical shaping apparatus and optical shaping process

(75) Inventor: Goro Fujita, Osaka (JP)

Correspondence Address: ARENT FOX KINTNER PLOTKIN & KAHN, PLLC, 1050 Connecticut Avenue, N.W., Suite 600, Washington, DC, 20036-5339, US

(73) Assignee: SANYO ELECTRIC CO., LTD

(21) Appl. No.: 09/867,385

(22) Filed: May 31, 2001

(30) Foreign Application Priority Data
May 31, 2000 (JP) 2000 - 162837
Jun. 6, 2000 (JP) 2000 - 168998

(51) Int. Cl. B29C 35/08; B29C 41/22; B29C 43/18; B29C 51/20; B29C 59/16; B29B 17/00

(52) U.S. Cl. 264/401; 425/174.4

(57) ABSTRACT

The invention provides an optical shaping apparatus comprising a stage 1 having a light transmitting portion 11, an irradiator 4 disposed below the stage 1, a table 3 disposed above the stage 1 and having a resin supply hole provided with an opening in a rear surface thereof, a lift mechanism 2 for driving the table 2 upward and downward, an optical shaping control unit 8 for controlling the operation of the lift mechanism 2 and the irradiator 4, and a resin supply tank 5 for supplying an uncured resin to the resin supply hole of the table 3. The uncured resin is filled into a space between the table 3 or a cured resin layer formed on the rear surface of the table 3 and the stage 1 to form an uncured resin layer of predetermined thickness, and the resin layer is irradiated with light over a region thereof in conformity with contour line data. The apparatus is shortened in shaping time, simplified in construction and compacted.

### TECHNICAL FIELD

The present invention relates to apparatus and a process for producing optically shaped articles of predetermined three-dimensional shape by irradiating layers of photosetting resin with light to cure the resin layers as superposed.

### BACKGROUND OF THE INVENTION

In developing various commodities such as electric devices, it is conventional practice to prepare a three-dimensional model of commodity and check the model for design or operation. With the life cycle of commodities shortened in recent years, there arises a need to produce three-dimensional model commodities within a shorter period of time. Accordingly, optical shaping apparatus have been developed for preparing a three-dimensional shaped article by irradiating the surface of a photosetting resin with a laser beam in a resin tank to cure the resin (U.S. Pat. No. 4,575,300, JP-B No 5-18704, etc.). However, the optical shaping apparatus described has the problem that the resin tank needed makes the apparatus large-sized. An optical shaping apparatus is therefore proposed which requires no resin tank (e.g., JP-B No. 7-90603).

FIG. 11 shows the optical shaping apparatus necessitating no resin tank. This apparatus comprises an irradiator 4 disposed as directed upward below a stage 10 having a light transmitting portion 11, and a table 3 to be driven upward or downward by a lift drive mechanism 20 and disposed above the stage 10. A lift drive circuit 21 is connected to the lift drive mechanism 20. The irradiator 4 and the lift drive circuit 21 have their operation controlled by an optical shaping control unit 8.

Further disposed above the stage 10 is a recoater 70 which is reciprocatingly movable horizontally along the surface of the stage 10. A resin supply tank 5 is connected to the recoater 70 by a resin supply pipe 54 provided with a pump 51. The recoater 70 is provided with a nozzle (not shown) for discharging a photosetting resin from the supply tank 5 and with a leveling plate (not shown) for leveling to a uniform thickness the photosetting resin delivered to the surface of the light transmitting portion 11 of the stage 10 from the nozzle.

With the optical shaping apparatus described, the table 3 is moved to a position higher than the recoater 70, the photosetting resin is thereafter discharged from the recoater 70 onto the surface of the stage 10, and the recoater 70 is reciprocatingly moved horizontally as indicated by arrows A to level the resin into a layer of uniform thickness. The table 3 is then lowered to bring the table 3 or a cured resin layer formed on the rear surface of the table 3 into contact with the layer of uncured resin on the stage 10. In this state, the uncured resin layer on the stage 10 is irradiated with light emanated from the irradiator 4. At this time, the region to be irradiated with the light is determined based on contour line data as to the article to be optically shaped. An excess of photosetting resin on the stage 10 returns to the resin supply tank 5 via a resin return pipe 55.

After the resin on the stage 10 is cured, the table 3 is raised again to a position higher than the recoater 70, and the photosetting resin is supplied, leveled and irradiated with light. Cured resin layers are successively formed as superposed on the rear side of the table 3 by repeating this procedure to eventually complete an intended shaped article 60 comprising superposed layers and having a three-dimensional shape.

The optical shaping apparatus shown in FIG. 11, however, has the problem of a prolonged shaping time not only because it is necessary to reciprocatingly move the recoater 70 horizontally as indicated by the arrows A to level the uncured resin on the stage 10 to a uniform thickness but also because the table 3 needs to be reciprocatingly moved greatly between a lowered position close to the stage 10 and a raised position higher than the recoater 70 as indicated by the arrows B in the illustration to permit the movement of the recoater.

The apparatus further requires a mechanism for reciprocatingly moving the recoater 70 and also the lift drive mechanism 20 of great height for reciprocatingly moving the table 3. The optical shaping apparatus therefore has the problem of becoming complex and large-sized.

Furthermore, the conventional optical shaping apparatus is likely to permit bubbles to become incorporated into the uncured resin when the resin is supplied onto the stage 10 by the recoater 70, and some of the bubbles remain in the uncured resin layer of uniform thickness formed by leveling by the recoater 70 to entail the problem that the bubbles will impair the strength of the shaped article of superposed layers.

### SUMMARY OF THE INVENTION

A first object of the present invention is to provide an optical shaping apparatus which is shortened in shaping time, simplified in construction and compacted.

A second object of the invention is to provide an optical shaping apparatus which is shortened in shaping time, simplified in construction, compacted and capable of producing a shaped article comprising superposed layers and free from bubbles.

To fulfill the first object, the present invention provides an optical shaping apparatus characterized in that the apparatus comprises:

a stage 1 permitting transmission of light through at least a central portion 11 thereof,

an irradiator 4 disposed below the stage 1 and directed toward the light transmitting portion 11 of the stage 1 for irradiating with light a region in conformity with contour line data representing the three-dimensional shape of an article to be optically shaped,

a table 3 disposed above the stage 1 and having a resin supply hole 31 provided with an opening in a rear surface thereof,

a lift mechanism 2 for vertically driving one of the stage 1 and the table 3 toward or away from the other,

an optical shaping control unit 8 for controlling the operation of the lift mechanism 2 and the irradiator 4, and

a resin feeder for supplying uncured resin to the resin supply hole 31 of the table 3,

the apparatus being operable to superpose cured resin layers 62 to obtain a shaped article 6 comprising superposed layers and having a predetermined three-dimensional shape by repeating the steps of filling the uncured resin 64 into a space between the table 3 or a cured resin layer 62 formed on the rear surface of the table 3 and the stage 1, forming an uncured resin layer 65 of predetermined thickness, and irradiating the resin layer 65 over an entire region thereof in conformity with the contour line data except a central region in register with the resin supply hole 31.

To operate the optical shaping apparatus of the invention, a space having a thickness larger than the thickness of the layer to be formed (pitch of layers to be superposed) is first provided between the table 3 and the stage 1, and is filled with the photosetting resin. The photosetting resin of the resin feeder is supplied to the space from the resin supply hole 31 of the table 3. The table 3 is then brought close to the stage 1 to make the spacing between the table 3 and the stage 1 equal to the predetermined thickness of the layer to be formed (pitch of layers to be superposed) to thereby compress the photosetting resin and form an uncured resin layer having the predetermined thickness.

When emanated from the irradiator 4 in this state, light passes through the light transmitting portion 11 of the stage 1, irradiating the uncured resin layer on the stage 1. At this time, the region to be irradiated with light is determined according to the contour line data as to the article to be optically shaped. Stated more specifically, the region to be irradiated is the entire region in conformity with the data except the central region in register with the resin supply hole 31.

As a result, the uncured resin layer on the stage 1 is cured over the irradiated region, and the cured resin layer adheres to the rear surface of the table 3. The central region of the uncured resin layer is not irradiated with light and remains uncured.

Next, the table 3 is moved away from the stage 1 to provide a space like the aforementioned one between the cured resin layer adhering to the rear surface of the table 3 and the stage 1. The space is filled with the photosetting resin. At this time, the uncured resin portion in register with the resin supply hole 31 is formed in the central region of the cured resin layer adhering to the rear surface of the table 3. Since this central region permits the passage of the photosetting resin, the photosetting resin supplied to the resin supply hole 31 of the table 3 is supplied to the space via the central region.

The table 3 is thereafter similarly brought close to the stage 1 to make the spacing between the cured resin layer adhering to the rear side of the table 3 and the stage 1 equal to the predetermined thickness of the layer to be formed, whereby the photosetting resin is compressed to form an uncured resin layer having the predetermined thickness. The uncured resin layer is irradiated with light over a region in conformity with the contour line data.

The entire region conforming to the contour line data and excluding the central region in register with the resin supply hole 31 is also the region to be irradiated with light in this case. Thus, the uncured resin layer on the stage 1 is cured over the irradiated region, and the cured resin layer adheres to the first layer of cured resin. Since the central region of the uncured resin layer is not irradiated with light and remains uncured, this region provides a supply path for the photosetting resin for the next step.

The supply of photosetting resin, compression (leveling) and irradiation are thereafter similarly repeated to eventually obtain a shaped article 6 comprising superposed layers and having a predetermined three-dimensional shape.

Stated more specifically, the optical shaping control unit 8 repeatedly executes the step of moving the table 3 toward the stage 1 relative thereto to bring the table 3 or the cured resin layer 62 formed on the rear surface of the table 3 into contact with the stage 1, thereafter moving the table 3 away from the stage 1 relative thereto and filling the uncured resin 64 into a space between the table 3 or the cured resin layer 62 formed on the rear surface of the table 3 and the stage 1, the step of thereafter moving the table 3 toward the stage 1 relative thereto to compress the uncured resin 64 into an uncured resin layer 65 having a predetermined thickness, the step of determining a region over which the uncured resin layer 65 is to be irradiated with light, in accordance with the contour line data, and the step of irradiating the determined region with light.

Thus, the table 3 is moved away from the stage 1 relative thereto after the table 3 or the cured resin layer 62 formed on the rear surface of the table 3 is brought into contact with the stage 1, whereby the space created between the table 3 or the cured resin layer 62 formed on the rear surface of the table 3 and the stage 1 is given a negative pressure to produce an effect to aspirate the uncured resin 64. This eliminates the need to fill in the uncured resin 64 under pressure, further permitting the above space to be filled with the photosetting resin without leaving any voids at all time and therefore without permitting air to be incorporated into the filling resin. As a result, a shaped article of superposed layers is available free from bubbles.

Further stated more specifically, in determining the region of irradiation by the optical shaping control unit 8 for a plurality of resin layers constituting the article to be shaped, the region of irradiation for each of resin layers including the first layer in contact with the rear surface of the table 3 is determined by excluding the central region from the entire region conforming to the contour line data, and the irradiation region for the final layer remotest from the table 3 is determined without excluding the central region from the entire region conforming to the contour line data. Except for the final layer, the layers constituting the shaped article 6 and including the first layer have a central hole 67 formed therein, and the central hole 67 is closed with the final layer.

The article optically shaped according to the present invention has a central bore 67 extending from one end of the article toward the other end thereof in the direction of superposition of the layers. This renders the optically shaped article lightweight and realizes savings in the photosetting resin.

Stated specifically, the central bore 67 is open at one end thereof in the direction of superposition of the layers and closed at the other end thereof. Accordingly, the article thus shaped is made to have a leg at the open end portion and a head at the other end portion. The opening of the central bore 67 is then concealed as positioned in the leg portion and becomes no longer distinctly visible, hence an advantageous appearance.

With the optical shaping apparatus of the invention described above, photosetting resin is compressed between the table or a cured resin layer adhering to the rear surface of the table and the stage to form a resin layer of uniform thickness, so that the apparatus need not be provided with the recoater conventionally used. With the recoater omitted, the distance the table is moved relative to the stage is greatly reduced, with the result that the lift mechanism can be shorter in the distance of upward and downward movement. Accordingly, the present apparatus can be shortened in shaping time, simplified in construction and compacted.

To fulfill the second object, the present invention provides an optical shaping apparatus for producing an optically shaped article of predetermined three-dimensional shape by irradiating layers of photosetting resin with light based on contour line data representing the sectional shape of the article to cure the resin layers as superposed, the apparatus comprising:

a stage 1 having a light transmitting portion 12 in the form of a flat plate and so supported as to be drivable along a horizontal plane,

a horizontal drive mechanism for driving the stage 1 along the horizontal plane,

a resin feeder for supplying an uncured photosetting resin to a surface of the light transmitting portion 12 of the stage 1,

an irradiator 4 disposed below the stage 1 and directed toward a rear surface of the stage 1 for irradiating a region in conformity with the contour line data with light,

a table 3 disposed above the stage 1 and opposed to the irradiator 4, the table being movable upward and downward,

a lift drive mechanism 2 for driving the table 3 upward and downward, and

an optical shaping control unit 8 for controlling the operation of the horizontal drive mechanism, the lift drive mechanism 2 and the irradiator 4.

With the optical shaping apparatus of the invention described, the resin feeder first supplies uncured resin 62 to the light transmitting portion 12 of the stage 1, and the stage 1 is thereafter driven to transport the uncured resin 62 to an irradiating position. The table 3 is then lowered to thereby compress the uncured resin 62 on the stage 1 to a thickness equal to the pitch of superposed layers to be formed and form an uncured resin layer of uniform thickness between the stage 1 and the table 3. The air bubbles in the uncured resin 62 are forced out by the compression from the region to be irradiated with light. Subsequently, the uncured resin layer on the stage 1 is irradiated with light from the irradiator 4 over a region conforming to the contour line data. As a result, the resin in the irradiated region is cured, forming a first cured resin layer 61. The table 3 is thereafter raised to separate the cured resin layer 61 from the surface of the stage 1.

In forming a second cured resin layer 61, the stage 1 is similarly driven to transport the uncured resin 62 supplied to the light transmitting portion 12 of the stage 1 to the irradiating position. The table 3 is then lowered to compress the uncured resin 62 on the stage 1 to a thickness equal to the pitch of superposed layers to be formed with the cured resin layer 61 adhering to the table 3 and form an uncured resin layer 64 of uniform thickness between the stage 1 and the table 3. Subsequently, the uncured resin layer 64 on the stage 1 is irradiated with light from the irradiator 4 to form a second cured resin layer 61. The cured resin layer 61 adheres to the first cured resin layer 61. The table 3 is thereafter raised to separate the second cured resin layer 61 from the surface of the stage 1.

The formation of the cured resin layer 61 is thereafter repeated similarly to eventually form the contemplated shaped article 6 comprising superposed layers and having a three-dimensional shape.

Stated more specifically, the optical shaping control unit 8 executes the following control to realize the foregoing sequence of operations. The unit 8 repeatedly effects first control for driving the stage 1 with the uncured resin 62 supplied to the light transmitting portion 12 of the stage 1 to transport the uncured resin 62 to the irradiating position, second control for lowering the table 3 to compress the uncured resin 62 with the table 3 or the cured resin layer 61 adhering to a rear surface of the table 3, third control for irradiating the resulting uncured resin layer 64 formed on the stage 1 with light over a region conforming to the contour line data, and fourth control for raising the table 3 to separate the cured resin layer 61 formed by irradiation from the surface of the stage 1.

Further stated more specifically, the resin feeder comprises a recoater 7 for supplying the uncured resin 62 to the surface of the light transmitting portion 12 of the stage 1 and leveling the uncured resin 62 to an approximately uniform thickness at the same time. The uncured resin 62 supplied onto the stage 1 is then transported to the irradiating position, as leveled to an approximately uniform thickness.

Further stated more specifically, the uncured resin layer to be formed by the recoater 7 has a thickness at least twice the pitch of the superposed layers forming the shaped article 6. The uncured resin 62 is then compressed from the original thickness (at least twice the pitch of superposed layers) to a thickness of one half thereof at a high ratio by the step of lowering the table 3 and compressing the uncured resin 62 to a thickness equal to the pitch of superposed layers. Accordingly, even if the uncured resin 62 has many bubbles incorporated therein, the bubbles are forced out to the peripheral portion by the compression and removed to outside the region to be irradiated.

According to another specific construction, the stage 1 is so supported as to be rotatable in a horizontal plane, and the horizontal drive mechanism comprises a motor 13 for drivingly rotating the stage 1 in one direction.

With this specific construction, the photosetting resin is supplied from the resin feeder to the surface of the stage 1 in rotation, whereby a continuous striplike uncured resin layer is formed on the surface of the stage 1, and this uncured resin layer is sent to the irradiating position. The layer is irradiated with light, with the stage 1 held against rotation. The stage 1 is thereafter rotated through a small angle, and a new uncured resin layer is sent to the irradiating position.

Furthermore, the optical shaping control unit 8 alters the angle of rotation of the stage 1 in accordance with the size of the region to be irradiated with light by the irradiator 4. This makes it possible to completely rotate the stage 1 for the subsequent irradiation following the current irradiation, through a minimum angle required, thus contributing to the shortening of the shaping time.

With the optical shaping apparatus of the invention described, the uncured resin 62 supplied at the resin supplying position is transported to the irradiating position by driving the stage 1, and the uncured resin 62 is compressed to a uniform thickness equal to the pitch of the superposed layers to be formed by the table 3 or the cured resin layer, so that there is no need to move the resin feeder like the conventional recoater. This greatly reduces the distance of upward and downward movement of the table 3 conventionally required, consequently greatly shortening the shaping time. Furthermore, there is no need to use a tall lift drive mechanism for moving the table 3 upward and downward, whereby the optical shaping apparatus can be compacted. Since the air bubbles are forced out from the region of the uncured resin to be irradiated by compressing the uncured resin, the bubbles are unlikely to remain in the completed shaped article of superposed layers, which is therefore given a high strength.

### BRIEF DESCRIPTION OF THE DRAWINGS

FIG. 1 is a diagram showing the construction of a optical shaping apparatus according to a first embodiment of the invention;

FIG. 2 is a flow chart showing a control operation of the apparatus;

FIG. 3 is a diagram showing the steps of filling a photosetting resin, compressing the resin and irradiating the resin with light;

FIG. 4 is a diagram for illustrating the upward and downward movement of a table relative to a stage;

FIG. 5 includes views showing a shaped article of superposed layers in vertical section and horizontal sections;

FIG. 6 is a diagram showing the arrangement of components of an optical shaping apparatus according to a second embodiment of the invention;

FIG. 7 is a fragmentary side elevation of the optical shaping apparatus;

FIG. 8 is a flow chart showing the control operation of the optical shaping apparatus;

FIG. 9(a) and FIG. 9(b) are plan views for illustrating angles of rotation of a stage in accordance with the size of an irradiating region;

FIG. 10(a) and FIG. 10(b) are sectional views showing the step of compressing an uncured resin on the stage with cured resin layers adhering to a table; and

FIG. 11 is a diagram showing the construction of a conventional optical shaping apparatus.

### DETAILED DESCRIPTION OF EMBODIMENTS

Embodiments of the present invention will be described below in detail with reference to the drawings.

First Embodiment

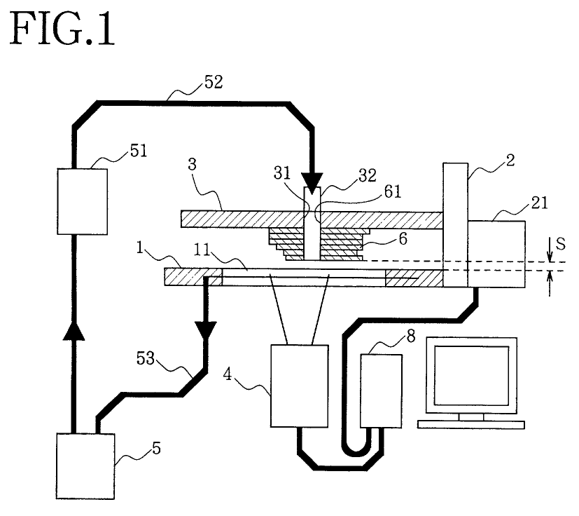

FIG. 1 shows an optical shaping apparatus of the first embodiment, which comprises an irradiator 4 of the projector type disposed as directed upward below a stage 1 having a light transmitting portion 11, and a table 3 to be driven upward and downward by a lift mechanism 2 and disposed above the stage 1. A lift drive circuit 21 is connected to the lift mechanism 2. The irradiator 4 and the lift drive circuit 21 have their operation controlled by an optical shaping control unit 8.

The table 3 has a resin supply hole 31 formed therein for supplying a photosetting resin to a space between the table 3 and the stage 1. A nozzle 32 extends through the hole 31. A resin supply tank 5 is connected to the nozzle 32 by a resin supply pipe 52 provided with a pump 51. The stage 1 is connected to the resin supply tank 5 by a resin return pipe 53 for returning an excess of uncured resin on the stage 1 to the resin supply tank 5.

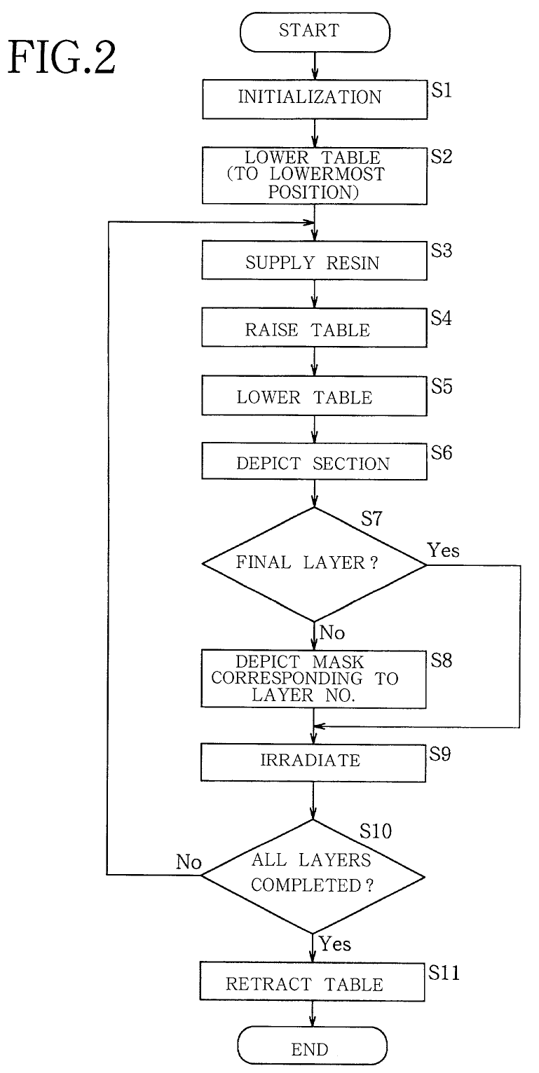

FIG. 2 shows the control procedure to be performed by the optical shaping control unit 8. First in step S1, an initial operation is performed for initialization, followed by step S2 in which the table 3 is lowered to the lowermost position where it is in contact with the stage 1. In the next step S3, the pump 51 is driven for the start of supply of the photosetting resin, and in step S4, the table 3 is raised by a predetermined distance S (for example, of 4 mm). As a result, a space having a thickness S and formed between the table 3 and the stage 1 is filled with the photosetting resin.

The table 3 is then lowered by a predetermined distance in step S5 to reduce the spacing between the table 3 and the stage 1 to a distance equal to a predetermined thickness t (for example, of 0.2 mm) of the layer to be formed, whereby the uncured resin between the table 3 and the stage 1 is compressed to the predetermined thickness of the layer to be formed.

Based on contour line data as to this section, the shape of the section is thereafter depicted in step S6. An inquiry is made in step S7 as to whether the resin layer for forming the section is the final layer. If the inquiry is answered in the negative, a mask corresponding to the layer number is depicted in step S8. For example, for a plurality of layers including the first layer adhering to the table 3, a mask of large area is depicted, and the area of the mask is gradually decreased for the subsequent layers (except the final layer). A region corresponding to the section excluding the region of the mask is determined as the region to be irradiated.

If the inquiry of step S7 is answered in the affirmative, on the other hand, step S8 is skipped to determine an irradiation region without excluding the region of mask from the section. The uncured resin layer is irradiated with light over the irradiation region in step S9, whereby the uncured resin layer is cured over the irradiation region, while the uncured resin layer is not cured over the region not exposed to the light. Accordingly, an uncured resin portion shaped in conformity with the shape of the mask is formed at the central portion of the resin layer other than the final layer to provide a flow channel for the resin for the subsequent resin layer forming step.

An inquiry is thereafter made as to whether all layers are irradiated with light in step S10. When the inquiry is answered in the negative, the sequence returns to step S3 to repeat steps S3 to S10. When the answer to the inquiry of step S10 is affirmative, step S11 follows to bring out the table form operation to complete a sequence of steps.

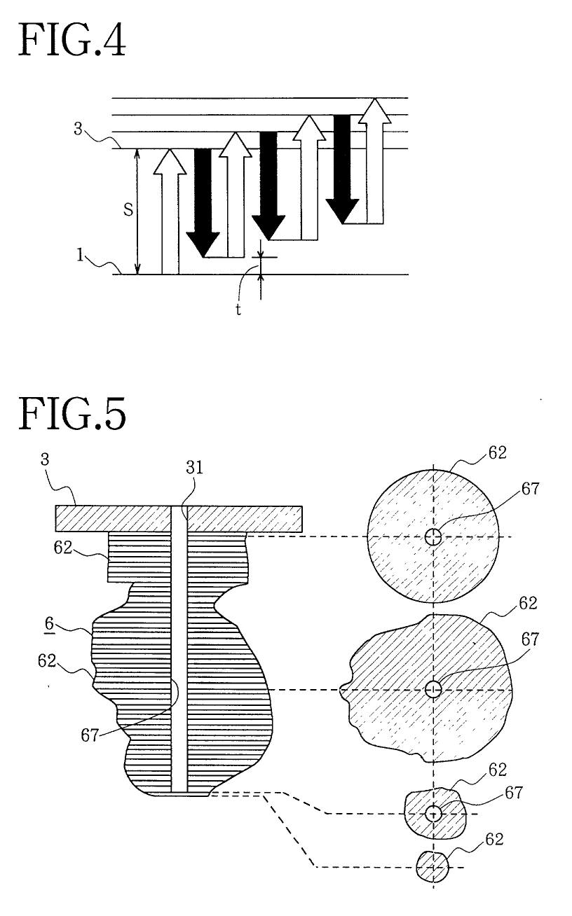

FIG. 4 shows how the table 3 is raised gradually while being repeatedly moved upward and downward relative to the stage 1 during the above procedure. First, the table 3 is raised by a predetermined distance S out of contact with the stage 1 to fill the resulting space with the resin. The table 3 is then lowered by the predetermined distance S minus the thickness t of the layer to be formed, i.e., the distance S-t, to compress the resin. By repeating this up-and-down movement, an article is gradually shaped which comprises superposed layers each having a thickness t.

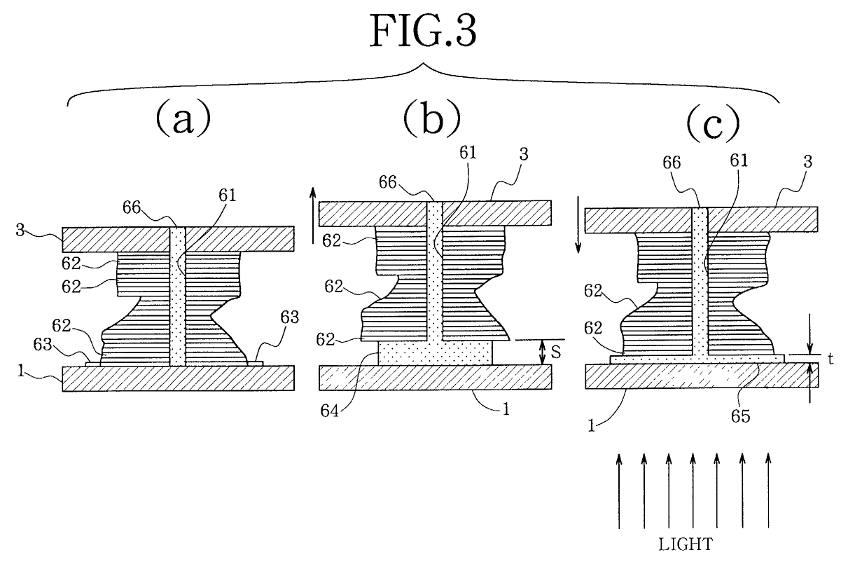

FIG. 3 shows how the article of superposed layers is gradually shaped between the stage 1 and the table 3. FIG. 3(a) shows a resin flow channel 61 extending vertically through cured resin layers 62 and filled with the uncured resin 66. The uncured resin 64 is filled into the space between the lowermost cured resin layer 62 and the stage 1 by a suction force produced by raising the table 3 as seen in FIG. 3(b) and the force of the pump 51. The table 3 is thereafter lowered as shown in FIG. 3(c), whereby the uncured resin 64 having a thickness S is compressed into an uncured resin layer 65 having a thickness t.

The uncured resin layer 65 is irradiated with light in this state, whereby the resin layer is cured over the irradiation region to form a cured resin layer 62, and a resin flow channel 61 in the form of an uncured resin portion is formed at the central portion of the cured resin layer 62. A small portion of uncured resin 63 remains around the cured resin layer 62 as seen in FIG. 3(a).

FIG. 5 shows the shaped article 6 comprising superposed layers and thus produced in vertical section and horizontal sections at some levels. As illustrated, all the cured resin layers 62 except for the final layer are centrally provided with a central bore 67 in communication with the resin supply hole 31 of the table 3 and closed with the final cured resin layer 62. Accordingly, the central bore 67 has an opening in the surface of the shaped article 6 in contact with the table 3, while the other surface of the article 6 toward the final layer can be finished with a curved face having no opening. In the case where a bust of a person is to be shaped, it is suitable to superpose layers from chest toward the head, since the head can then be finished with a curved surface having no opening. The shaped article 6 can be easily separated from the table 3.

With the optical shaping apparatus of the present invention, layers are superposed with the photosetting resin always filling the space between the stage 1 and the table 3 or the cured resin layer 62 adhering to the table 3. This obviates the likelihood that air will be incorporated into the resin to provide the shaped article 6 free from air bubbles.

The photosetting resin is made into a resin layer of uniform thickness by being compressed between the stage 1 and the table 3 or the cured resin layer 62 adhering to the rear surface of the table 3. This eliminates the need for the recoater 7 used in the conventional optical shaping apparatus, consequently providing a simplified apparatus. Since there is no need to raise the table 3 to a high level for filling the resin, the lift mechanism 2 can be shorter in the distance of vertical movement, consequently realizing a compacted apparatus, greatly reducing the time taken for the table 3 to move upward and downward and resulting in a shorter shaping time than conventionally.

According to the foregoing embodiment, the central bore 67 of the shaped article 6 merely serves as a resin flow channel and has an approximately uniform inside diameter, whereas this is not limitative; the bore may vary greatly in inside diameter so as to have a desired shape. The central bore 67 can be of a further increased inside diameter in conformity with the contour of the shaped article 6 so as to give an approximately uniform wall thickness to the article as finished. In this case, the shape of the masks may be expressed as a function of the layer number.

Second Embodiment

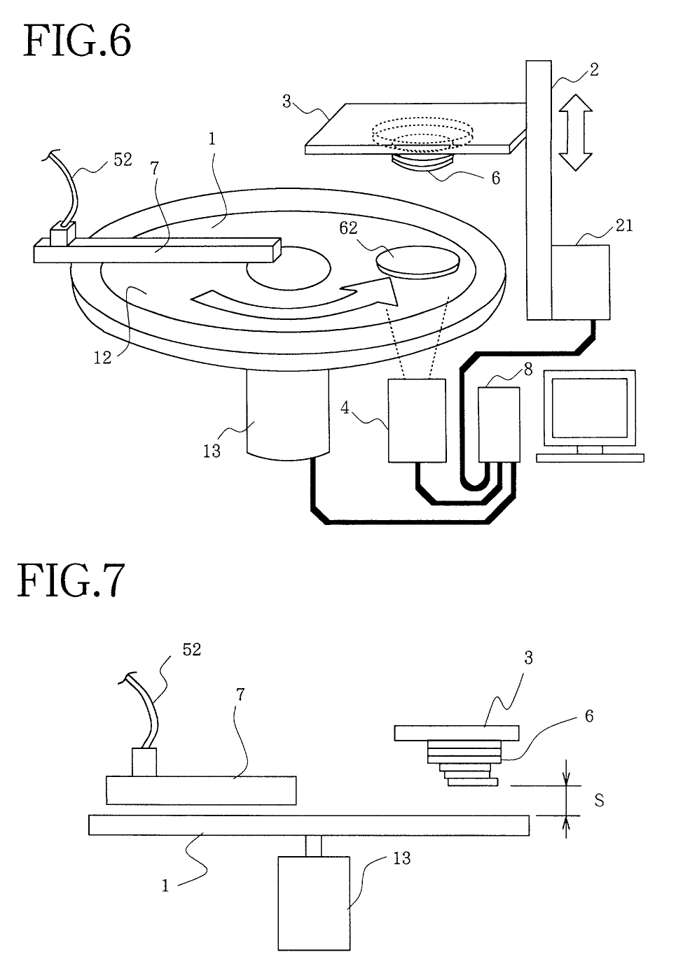

FIGS. 6 and 7 show an optical shaping apparatus according to a second embodiment, which comprises a disklike stage 1 having a light transmitting portion 12 over an annular region. The stage 1 is driven by a motor 13 in a horizontal plane. Disposed along the surface of the stage 1 is a recoater 7 for supplying an uncured resin to the light transmitting portion 12 to provide a resin supply position. The recoater 7 is connected to a resin pump and a resin tank (neither shown) by a resin supply pipe 52.

At a position 180 deg away from the resin supply position about the center of the stage 1, an irradiator 4 of the projector type is disposed as directed upward below the stage 1 to provide an irradiating position. A table 3 is disposed above the stage 1 and opposed to the irradiator 4. The table 3 is attached to an output portion of a lift drive mechanism 2, which is driven by a lift drive circuit 21 for moving the table 3 upward and downward.

The drive motor 13, the irradiator 4 and the lift drive circuit 21 have their operation controlled by an optical shaping control unit 8. The pump is so controlled as to supply the uncured resin onto the surface of the light transmitting portion 12 of the stage 1 at a predetermined flow rate with the rotation of the stage 1, whereby an uncured resin layer 62 of approximately uniform thickness is formed on the surface of the light transmitting portion 12 of the stage 1. Preferably, the uncured resin layer 62 has a thickness at least twice the pitch (e.g., 0.2 mm) of superposed layers to be formed.

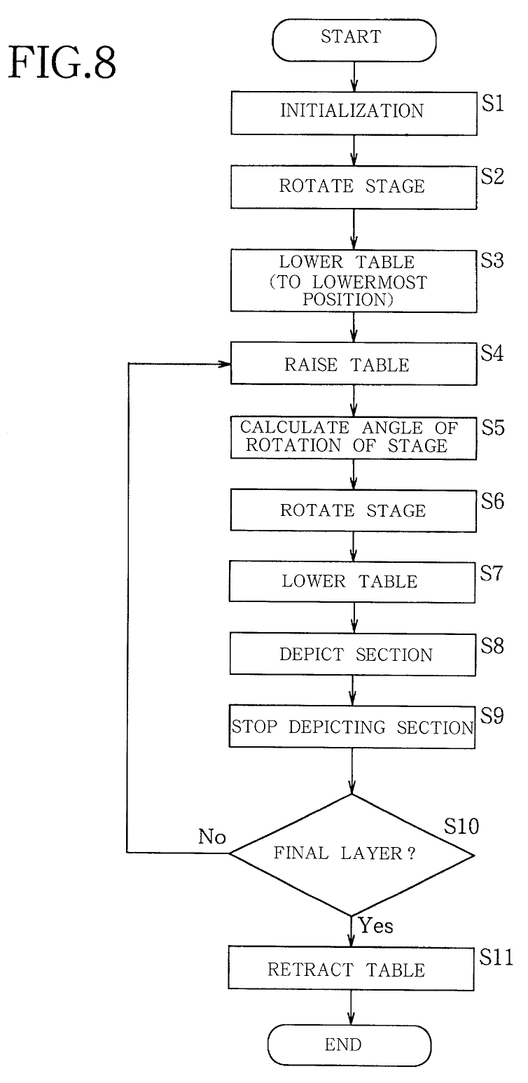

FIG. 8 shows the control procedure to be performed by the optical shaping control unit 8. First in step S1, an initial operation is performed as required for initialization. The stage 1 is thereafter rotated and set in an initial position in step S2, and the table 3 is then lowered in step S3 to the lowermost position where it is in contact with the stage 1. Subsequently in step S4, the table 3 is raised by a predetermined distance S (e.g., 4 mm) greater than the thickness of the uncured resin layer 62.

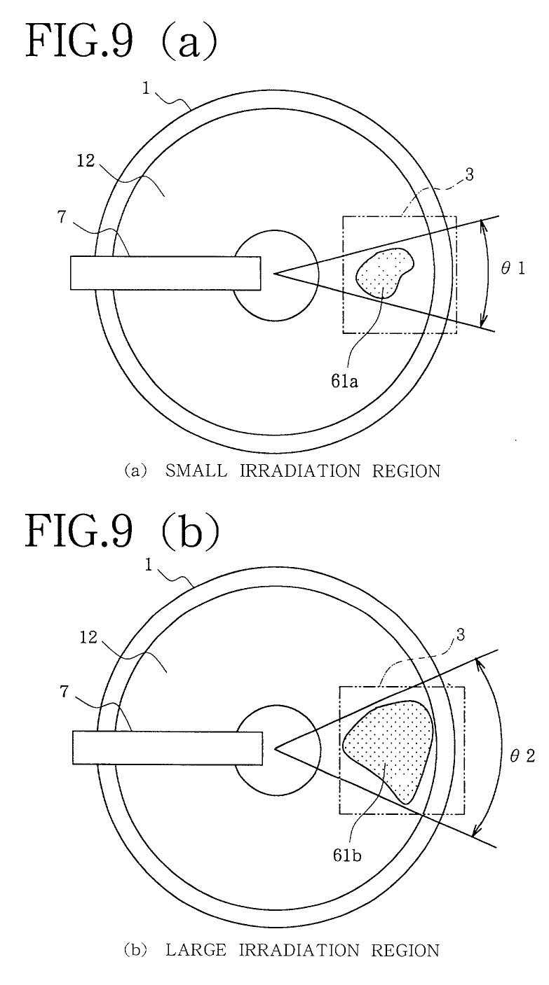

The angle of rotation of the stage 1 is calculated in accordance with the size of the region of irradiation in the next step S5. For example, in the case of a small irradiation region 61a as shown in FIG. 9(a), a small angle □1 of rotation capable of moving the region away from the irradiating position is calculated, while in the case of a large irradiation region 61b as shown in FIG. 9(b), a large angle □2 of rotation for retracting the region from the irradiating position is calculated.

The stage 1 is then rotated through the calculated angle in step S6 of FIG. 8, and the table 3 is lowered in step S7 to reduce the spacing between the table 3 and the stage 1 or a cured resin layer adhering to the stage 1 to a distance equal to the predetermined pitch t (0.2 mm) of the superposed layers to be formed, whereby the uncured resin 62 on the stage 1 is compressed to a thickness equal to the predetermined pitch.

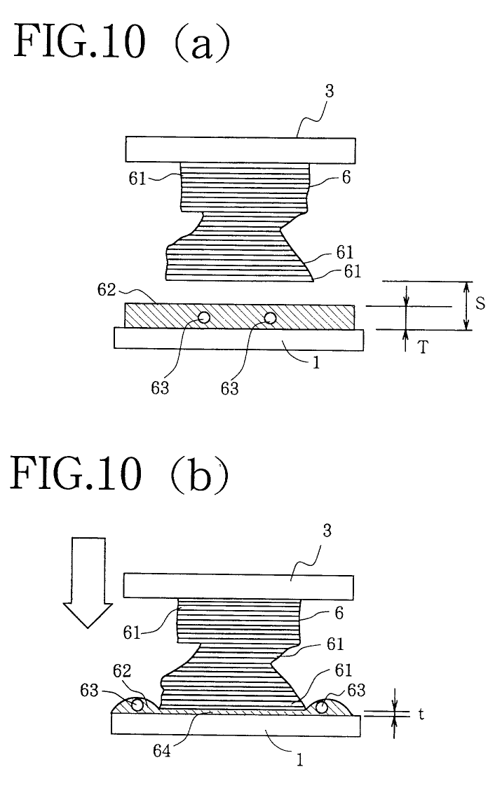

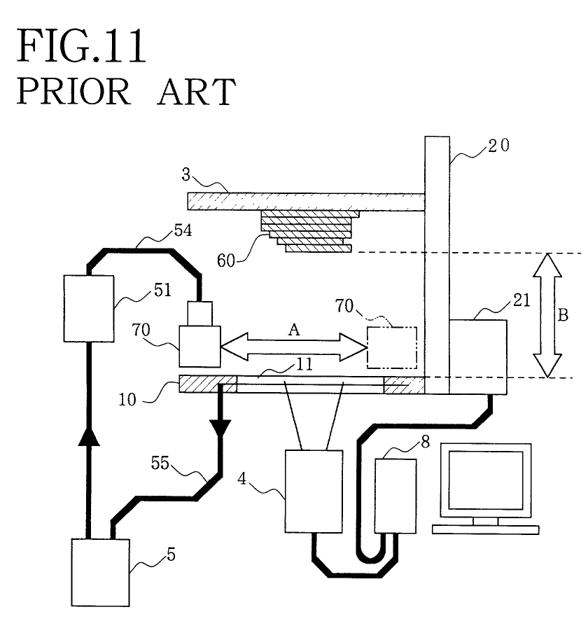

FIGS. 10(a) and 10(b) show the step of compressing the uncured resin 62 on the stage 1 with the lowermost cured resin layer 61 adhering to the table 3 by lowering the table 3. The table 3 is raised to provide a predetermined distance S (4 mm) between the stage 1 and the lowermost cured resin layer 61 adhering to the table 3, and the uncured resin 62 having a thickness T (2 mm) is formed on the stage 1 as seen in FIG. 10(a). From this state, the table 3 is lowered as seen in FIG. 10(b), causing the lowermost cured resin layer 61 to compress the uncured resin 62 on the stage 1 to form an uncured resin layer 64 having a thickness equal to the predetermined pitch t (0.2 mm) of the superposed layers to be formed. The air bubbles 63 contained in the uncured resin 62 is forced out by this compressing step from the region of compression and removed from the uncured resin layer 64.

The uncured resin layer 64 is thereafter irradiated with light based on contour line data as to the section concerned, depicting the shape of the section in step S8 of FIG. 8, and section depiction is discontinued in step S9. The irradiation is effected for a period of time (e.g., 3.8 sec) predetermined according to the thickness (0.2 mm) of the uncured resin layer 64.

Subsequently in step S10, an inquiry is made as to whether the resin layer is the final layer. If the inquiry is answered in the negative, the sequence returns to step S4 to repeat the depiction of section by irradiation and superpose a cured resin layer. When answer to the inquiry of step S10 is found affirmative, step S11 follows to move the table out of operation and complete a sequence of steps.

The table 1 is gradually raised while being repeatedly moved upward and downward relative to the stage 1 by executing the above procedure as is the case with the first embodiment shown in FIG. 4. First, the table 3 is raised by a predetermined distance S out of contact with the stage 1, and the table 3 is then lowered by the predetermined distance S minus the thickness t of the layer to be formed, i.e., the distance S-t, to compress the resin. By repeating this up-and-down movement, an article is shaped gradually which comprises superposed layers each having a thickness t.

With the optical shaping apparatus of the invention described, the uncured resin 62 on the stage 1 is compressed by the table 3 or the cured resin layer 61 adhering to the table 3 to remove air bubbles from the resin in the irradiation region. A shaped article 6 of superposed layers is therefore available which is free from bubbles and has a high strength.

The recoater 7 supplies the uncured resin 62 onto the surface of the stage 1 in rotation and levels the uncured resin 62 to an approximately uniform thickness at the same time. This eliminates the need to move the recoater 7. The uncured resin 62 is transported to the irradiating position by the rotation of the stage 1, so that the table 3 can be installed in a position free of interference with the stage 1. The stage 1 therefore needs only to be raised by a small distance S as required for compressing the uncured resin. Whereas the table 3 is moved up and down over a great distance while reciprocatingly moving the recoater 70 horizontally in the conventional optical shaping apparatus, the apparatus of the invention is accordingly greatly shortened in shaping time. The lift drive mechanism 2 can be shorter in the distance of upward and downward movement to render the apparatus compacted.

Although the stage 1 of the foregoing embodiment is in the form of a disk and made to rotate in a horizontal plane, the stage so constructed is not limitative; also usable is a stage which is reciprocatingly movable horizontally or one adapted for both rotation and reciprocating movement in combination.

What is claimed is:

1. An optical shaping apparatus for producing an optically shaped article of predetermined three-dimensional shape by irradiating layers of photosetting resin with light based on contour line data representing the three-dimensional shape of the article to cure the resin layers as superposed, the optical shaping apparatus being characterized in that the apparatus comprises:
a stage (1) permitting transmission of light through at least a central portion (11) thereof,
an irradiator (4) disposed below the stage (1) and directed toward the light transmitting portion (11) of the stage (1) for irradiating with light a region in conformity with contour line data representing the three-dimensional shape of an article to be optically shaped,
a table (3) disposed above the stage (1) and having a resin supply hole (31) provided with an opening in a rear surface thereof,
a lift mechanism (2) for vertically driving one of the stage (1) and the table (3) toward or away from the other, an optical shaping control unit (8) for controlling the operation of the lift mechanism (2) and the irradiator (4), and
a resin feeder for supplying uncured resin to the resin supply hole (31) of the table (3),
the apparatus being operable to superpose cured resin layers (62) to obtain a shaped article (6) comprising superposed layers and having a predetermined three-dimensional shape by repeating the steps of filling the uncured resin (64) into a space between the table (3) or a cured resin layer (62) formed on the rear surface of the table (3) and the stage (1), forming an uncured resin layer (65) of predetermined thickness, and irradiating the resin layer (65) over an entire region thereof in conformity with the contour line data except a central region in register with the resin supply hole (31).

2. An optical shaping apparatus according to claim 1 wherein the optical shaping control unit (8) repeatedly executes the step of moving the table (3) toward the stage (1) relative thereto to bring the table (3) or the cured resin layer (62) formed on the rear surface of the table (3) into contact with the stage (1), thereafter moving the table (3) away from the stage (1) relative thereto and filling the uncured resin (64) into a space between the table (3) or the cured resin layer (62) formed on the rear surface of the table (3) and the stage (1), the step of thereafter moving the table (3) toward the stage (1) relative thereto to compress the uncured resin (64) into an uncured resin layer (65) having a predetermined thickness, the step of determining a region over which the uncured resin layer (65) is to be irradiated with light, in accordance with the contour line data, and the step of irradiating the determined region with light.

3. An optical shaping apparatus according to claim 2 wherein in determining the region of irradiation by the optical shaping control unit (8) for a plurality of resin layers constituting the article to be shaped, the region of irradiation for each of resin layers including the first layer in contact with the rear surface of the table (3) is determined by excluding the central region from the entire region conforming to the contour line data, and the irradiation region for the final layer remotest from the table (3) is determined without excluding the central region from the entire region conforming to the contour line data.

4. An optical shaping process for producing an optically shaped article of predetermined three-dimensional shape by irradiating layers of photosetting resin with light based on contour line data representing the three-dimensional shape of the article to cure the resin layers as superposed, the optical shaping process being characterized by repeatedly executing:
the step of moving a table (3) toward a stage (1) relative thereto to bring the table (3) or a cured resin layer (62) formed on a rear surface of the table (3) into contact with the stage (1), thereafter moving the table (3) away from the stage (1) relative thereto and filling an uncured resin (64) into a space between the table (3) or the cured resin layer (62) formed on the rear surface of the table (3) and the stage (1),
the step of thereafter moving the table (3) toward the stage (1) relative thereto to compress the uncured resin (64) into an uncured resin layer (65) having a predetermined thickness,
the step of determining a region over which the uncured resin layer (65) is to be irradiated with light, in accordance with the contour line data,
the step of irradiating the determined region with light, and
the step of moving the table (3) away from the stage (1) relative thereto to separate a cured resin layer (61) formed by irradiation from the surface of the stage (1).

5. An optical shaping apparatus for producing an optically shaped article of predetermined three-dimensional shape by irradiating layers of photosetting resin with light based on contour line data representing the sectional shape of the article to cure the resin layers as superposed, the optical shaping apparatus being characterized in that the apparatus comprises:
a stage (1) having a light transmitting portion (12) in the form of a flat plate and so supported as to be drivable along a horizontal plane,
a horizontal drive mechanism for driving the stage (1) along the horizontal plane,
a resin feeder for supplying an uncured photosetting resin to a surface of the light transmitting portion (12) of the stage (1),
an irradiator (4) disposed below the stage (1) and directed toward a rear surface of the stage (1) for irradiating a region in conformity with the contour line data with light,
a table (3) disposed above the stage (1) and opposed to the irradiator (4), the table being movable upward and downward, a lift drive mechanism (2) for driving the table (3) upward and downward, and
an optical shaping control unit (8) for controlling the operation of the horizontal drive mechanism, the lift drive mechanism (2) and the irradiator (4).

6. An optical shaping apparatus according to claim 5 wherein the optical shaping control unit (8) repeatedly executes first control for driving the stage (1) with the uncured resin (62) supplied to the light transmitting portion (12) of the stage (1) to transport the uncured resin (62) to the irradiating position, second control for lowering the table (3) to compress the uncured resin (62) with the table (3) or a cured resin layer (61) adhering to a rear surface of the table (3), third control for irradiating the resulting uncured resin layer (64) formed on the stage (1) with light, and fourth control for raising the table (3) to separate the cured resin layer (61) formed by irradiation from the surface of the stage (1).

7. An optical shaping apparatus according to claim 5 wherein the resin feeder comprises a recoater (7) for supplying the uncured resin (62) to the surface of the light transmitting portion (12) of the stage (1) and leveling the uncured resin (62) to an approximately uniform thickness at the same time.

8. An optical shaping apparatus according to claim 7 wherein the uncured resin layer to be formed by the recoater (7) has a thickness at least twice the pitch of the superposed layers to be formed.

9. An optical shaping apparatus according to claim 5 wherein the stage (1) is so supported as to be rotatable in a horizontal plane, and the horizontal drive mechanism comprises a motor (13) for drivingly rotating the stage (1) in one direction along a horizontal plane.

10. An optical shaping apparatus according to claim 9 wherein the optical shaping control unit (8) alters the angle of rotation of the stage (1) in accordance with the size of the region to be irradiated with light by the irradiator (4).

11. An optical shaping process for producing an optically shaped article of predetermined three-dimensional shape by irradiating layers of photosetting resin with light based on contour line data representing the sectional shape of the article to cure the resin layers as superposed, the optical shaping process being characterized by repeatedly executing:
the step of driving a stage (1) in a horizontal direction with the uncured resin (62) supplied to a light transmitting portion (12) of the stage (1) to transport the uncured resin (62) to an irradiating position,
the step of lowering a table (3) to compress the uncured resin (62) with the table (3) or a cured resin layer (61) adhering to a rear surface of the table (3),
the step of irradiating the resulting uncured resin layer (64) on the stage (1) with light, and
the step of raising the table (3) to separate the cured resin layer (61) formed by irradiation from a surface of the stage (1).
